(19) United States
(12) Patent Application Publication
(10) Pub. No.: US 2006/0222858 A1
(43) Pub. Date: Oct. 5, 2006

(54) Flexible dry erase/ instructional magnets

(76) Inventor: Joseph A. Haas, Norton, OH (US)

Correspondence Address: JOSEPH A. HAAS, 2645 HAMETOWN RD, NORTON, OH, 44203, US

(21) Appl. No.: 11/367,494

(22) Filed: Mar. 4, 2006

Related U.S. Application Data
(60) Provisional application No. 60/664,972, filed on Mar. 24, 2005.

(51) Int. Cl. B32B 27/38

(52) U.S. Cl. 428/413

(57) ABSTRACT

A dry erase magnet made of a transparent dry erase film top layer for allowing dry erase marker markings to be wiped off. Prior to application of the dry erase layer, the opaque vinyl layer of the magnet substrate may be printed on directly with a layout or design for a specific use.

This patent takes the benefit of provisional patent No. 60/664,972 dated Mar. 24, 2005.

### BRIEF SUMMARY OF THE INVENTION

A magnet made of a flexible substrate that may have a printed layout or design and a transparent dry erase film is applied for the top layer. If the design or layout requires dry erase, a dry erase film layer with adhesive backing is applied to flexible magnet substrate to allow for dry erase marker markings and wiped off.

### DETAILED DESCRIPTION OF THE INVENTION

A dry erase magnet made of a transparent dry erase film top layer for allowing dry erase marker markings to be wiped off. The dry erase film layer with adhesive backing is applied to a flexible magnet substrate that has a vinyl top layer. Prior to application of the dry erase layer, the opaque vinyl layer of the magnet substrate may be printed on directly with a layout for a specific use. Just to name a few examples such as lettering lines, music lines, coaches layouts, games, charts, words, symbols, diagrams; versatile for any kind of application). The magnets may be used individually or used as a kit for a specific purpose with a group.

These individual magnets can be any size and be rectangular or cut to a specific shape. The magnets may be used individually or in kits. They would provide a means for multiple markings with a writing device such as a dry erase marker and erasings without the need for drawing/rewriting repetitive items. Thus giving the user a flexible dry erase magnet capability. If dry erase is not a requirement for the specific use, then the dry erase film layer does not need to be applied.

### REFERENCES CITED

Examples of past dry erase boards may be found in several prior art patents, such as
U.S. Pat. No. 6,647,652
U.S. Pat. No. 6,272,779
U.S. Pat. No. 6,263,602
U.S. Pat. No. 5,527,568
U.S. Pat. No. 5,655,323
U.S. Pat. No. 5,658,635
U.S. Pat. No. 5,948,498

However, all these patents have the use of a rigid board for the backing substrate which has limits on transport and storage.

Another example of dry erase patent is U.S. Pat. No. 5,741,561 which describes the use of a double walled placemat with a clear top sheet provided with one or more sides open for inserting a piece of paper in the pocket. This invention still relies on the use of a piece of paper as the insert. The present patent utilizes a stationary printed format that can be marked on over and over due to the dry erase film surface.

It is understood that the present invention is not limited to the embodiments of any examples given in this application.

### DESCRIPTION OF THE DRAWING

The following drawing page (Page 1 of 1) is as described below:

FIG. 1A. The substrate is made of a flexible magnet backing material.
1. The substrate is a magnet with an opaque vinyl top layer surface.
2. The substrate can be direct printed with a design or layout on the surface.

FIG. 1B. The top layer is made of a transparent film with an adhesive backing for attaching to the magnet substrate layer.

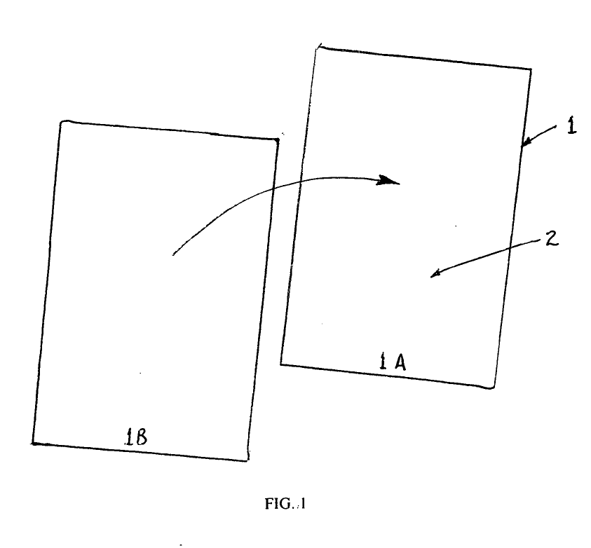

1. It is the object of the present invention to provide a flexible magnet dry erase surface which has no frame, board or rigid substrate which does not allow the ease of transport or storage that the invention's thinner, flexible substrate allows.

2. Per claim 1, another object is to provide a portable, stack-able, roll-able magnet surface for dry erase marking.

3. Another object is to provide a flexible magnet substrate with an opaque vinyl top layer which can have a layout or design directly printed on the surface. A couple of examples of direct printing processes are screen printing, inkjet printing or flatbed printing.

4. Per claim 3, another object is the design of the printed layout or designs to allow for the user to take advantage of not having to draw/write repetitive items. An example of this could be an aid for informational, educational, or instructional uses such as lettering lines for writing, chart form for logging information, layouts for sports fields, educational layouts or designs, games and other layouts or designs.

5. Per claim 3, another object is that any layouts or designs that are printed on the magnet substrate can be customized for many different activities for different levels.

6. Per claim 3, another object is that these many varieties of layouts or designs may be used for many different educational, instructional, entertainment or other fields of employment.

7. Another object is to provide the opportunity to use the dry erase magnet in lieu of writing on a dry erase board or other blackboard surfaces which will provide multiples uses. The hand writing type system only allows for one time use and remarking after erased.

8. Per claim 7, another object is that the magnetic substrate allows for applying to other surfaces for uses where a dry erase board is not available. One example is placing on a metal door or metal lockers. This allows for instruction and other uses due to its portability.

9. Per claim 7, the existing dry erase board has multiple materials & several steps to manufacture in lieu of present patent of printing on substrate & adding a dry erase layer.

10. Per claim 7, the entire magnet may be displayed on a vertical metal surface.
